(19) United States
(12) Patent Application Publication
(10) Pub. No.: US 2022/0355409 A1
(43) Pub. Date: Nov. 10, 2022

(54) Hollow welding pin for assembling two different materials.

(71) Applicant: LISI AUTOMOTIVE, GRANDVILLARS (FR)

(72) Inventors: David MERCS, BELFORT (FR); Maxime SALLERIN, BELFORT (FR)

(21) Appl. No.: 17/620,988

(22) PCT Filed: Jun. 19, 2020
(86) PCT No.: PCT/FR2020/000188

§ 371 Date: Dec. 20, 2021

(30) Foreign Application Priority Data
Jun. 20, 2019 (FR) FR1906672
Jun. 18, 2020 (FR) FR2006389

(51) Int. Cl. B23K 11/00; B23K 11/18

(52) U.S. Cl. CPC B23K 11/0066; B23K 11/185; B23K 2101/006

(57) ABSTRACT

A method for assembling a sheet (40) and an iron-based metal part (80) comprising a step of fitting a tubular pin (10) which is open at both ends by punching through the sheet (40) with a shank of the pin with the pin being retained (10) by the sheet, wherein a pad is detached from the first sheet (40), and a flange of the pin abuts against the surface of the sheet (40) once the through-punching has been carried out, and the elastic returns of the shank of the pin (10) and the sheet (40) compress the outer surface of the shank, or by overmoulding the pin in the sheet, and subsequently a step of welding a metal tube of the pin (10) to the iron-based metal part (80) by bringing a flee end (24) of the metal tube into contact with the surface of the iron-based metal part (80) by means of electric resistance welding (90).

The invention concerns the assembling of materials of different type unable to be directly resistance welded. The targeted structures are particularly those of automotive vehicles such as vehicle bodies to contribute towards weight reduction and the reduction of greenhouse gas emissions. For example, the invention concerns the mechanical assembling of steel sheet with sheet in an aluminium alloy such as Al—Si—Mg or Al—Si—Mg—Mn, or in a composite material or a thermoplastic polymer with or without fibre reinforcement. It is known to use rivets and electric welding, but the shafts of rivets are not retained by the punched sheet which complicates use before welding. In addition, this being a major problem, rivet heads increase the weight of the assembly.

The invention also concerns a hollow welding pin to allow the mechanical assembly of different types of sheet material with a maximum reduction in the weight gain induced by welding pins to achieve the objective of lightweighting automotive vehicles. Therefore, the assembly element is a pin which, via its form factor, is retained by punched sheet thereby facilitating use before welding. Additionally, the hollow nature of the pin significantly reduces assembly weight thereby affording substantial advancement.

To reach this objective, there is proposed a method for assembling sheet with an iron-based metal part, comprising a step of fitting a tubular pin by punching through the sheet with a shank of the pin with the pin being retained by the sheet, a pad being detached from the sheet, a flange of the pin coming to abut the surface of the sheet once the through-punching has been carried out, or by overmoulding said shank in the sheet, and subsequently a step of welding a metal cylinder of the pin onto the iron-based metal part by bringing a free end of the metal cylinder into contact with the surface of the iron-based metal part and welding by electric resistance. According to another definition, assembling is obtained with a step to punch through the sheet with a hollow cylinder—or tube—in electrically conductive material of which one end has a bell mouth which comes to abut the surface of the sheet once through-punching or overmoulding has been performed, followed by a step to weld the hollow metal cylinder onto the iron-based metal part by contacting a free end of the hollow cylinder opposite the bell mouth with the surface of the iron-based metal part and applying an electric resistance welding electrode to the mouth of the bell mouth. And according to another definition of the invention, a hollow part is used, generally flat, of circular cross-section parallel to its plane, having an axis of symmetry of revolution, rigid and open at both ends. Therefore the method is a method for assembling sheet and an iron-based metal part comprising a step of fitting a through-passing tubular pin open at both ends by punching the sheet with a shank of said pin with retaining of said shank by the sheet, a flange of the pin coming to abut the surface of the sheet once through-punching has been performed, and the elastic returns of the pin shank and sheet compressing the outer surface of the shank, a pad (slug) being detached from the first sheet, or by overmoulding said shank in the sheet, followed by a step to weld a metal tube of the pin onto the iron-based metal part by contacting a free end of the metal tube with the surface of the iron-based metal part and welding via electric resistance.

With the hollow welding pin of the invention, it is possible:

to pass through metal, composite or thermoplastic sheet having thicknesses of 4 mm or less, then allowing rigid securing of the sheet with the pin after punching or overmoulding, while providing at least one accessible, even protruding, portion in the form of a ring surrounding a hollow, or ring portion, able to be welded by electric resistance;

to produce metal, composite or thermoplastic sheet fitted with one or more hollow welding pins of the invention, ready to be welded locally via electric resistance onto a second sheet mostly composed of iron (steel, stainless steel, even optionally cast iron in different applications) to produce a robust mechanical assembly between two materials that are unable to be directly welded together by electric resistance.

According to optional advantageous characteristics:
the electric resistance welding electrode is sized and applied so that all the angular sectors of the bell mouth are used simultaneously to transmit energy for welding;
the metal hollow cylinder (tube) is previously formed by stamping and cutting low-alloy steel sheet of thickness 0.5, 1 or 2 mm;
the metal part to be assembled is electrically earthed.

There is also proposed in the invention a sheet for mechanical assembly pre-fitted with a hollow pin comprising a hollow through cylinder (tube) in electrically conductive metal which, on one surface of the sheet has a bell mouth which comes to abut the surface of the sheet, and which on the other surface of the sheet has a free end. The sheet retains the hollow pin. It is also defined as sheet for mechanical assembly retaining a through tube open at both ends in electrically conductive metal which, on one surface of the sheet has a bell mouth abutting the surface of the sheet, and which on the other surface of the sheet has a free end.

According to optional advantageous characteristics:
the sheet can be aluminium alloy sheet, or sheet in thermoplastic polymer with or without fibre reinforcement, in particular long fibre reinforcement, or sheet in composite material having an organic or ceramic matrix with or without fibre reinforcement, in particular long fibre reinforcement;
the hollow metal cylinder (tube) can be in stamped low-alloy steel;
the material of the hollow metal cylinder can be held away from the material of the sheet by an additional cylinder of the pin, or additional tube, the free end of the hollow metal cylinder projecting from a free end of the additional cylinder;
the additional cylinder can be in stainless steel, hardened steel, or a non-metallic heat-refractory material;
the hollow metal cylinder and additional cylinder can be assembled by welding, bonding, clamping or plastic deformation between respective end flanges of the cylinders on the bell mouth side, or locked to each other by inserting a shim between an inner surface of the additional cylinder and an opposite-facing outer surface of the hollow metal cylinder, or by the presence on the inner diameter of the additional cylinder of radially projecting portions promoting embedding of the additional cylinder around the hollow metal cylinder;

The assembly may comprise electrical insulation between the material of the hollow metal cylinder and the material of the additional cylinder;

It may comprise a gap over the cylindrical development and height of the cylinder in electrically conductive material, between the material of the hollow metal cylinder and the material of the additional cylinder;
the free end of the hollow metal cylinder can be smooth or have an inner or outer chamfer, or have a waved perimeter, or crenellated perimeter.

The invention also consists of an assembly between sheet and an iron-based metal part comprising a hollow pin (tube) comprising a cylinder in electrically conductive metal passing through the sheet and having one end with a bell mouth abutting the surface of the sheet, the hollow metal cylinder being welded onto the iron-based metal part. It extends to an automotive vehicle, a structure of which includes at least one assembly of the invention.

There is also proposed a method for repairing an assembly or automotive vehicle of the invention, the shaft of a conductive metal pin composed of a head and shaft of chosen length for the repair being placed in the hollow of said electrically conductive metal cylinder, the head being placed against against the bell mouth of the cylinder and an electric welding electrode being applied to the head to weld the shaft to the sheet.

The invention is now described in connection with the Figures.

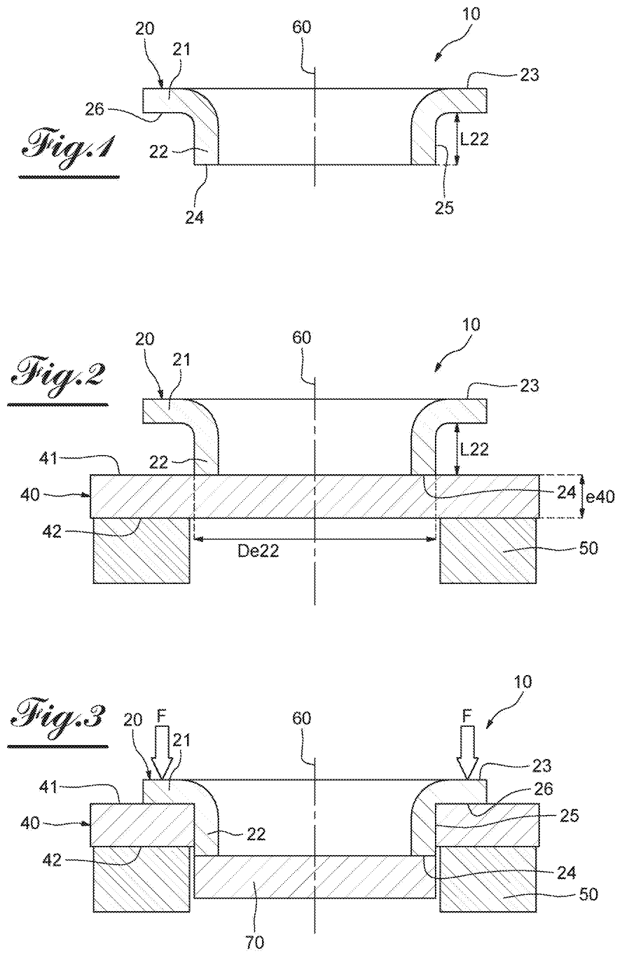

FIG. 1 is a cross-sectional view of a pin according to a first embodiment of the invention.

FIGS. 2 to 4 are cross-sectional views of successive steps of the implementation of a pin as in FIG. 1.

FIG. 5 is an explanation of the phenomena involved in the steps of the previously mentioned Figures.

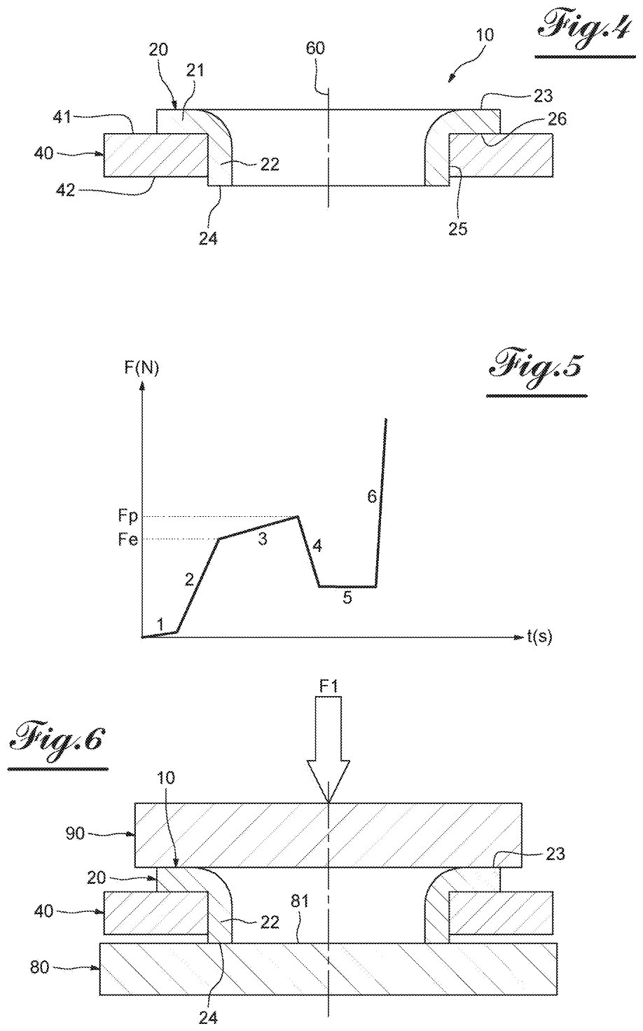

FIGS. 6 and 7 are cross-sectional views of subsequent successive steps of implementation of a pin as in FIG. 1.

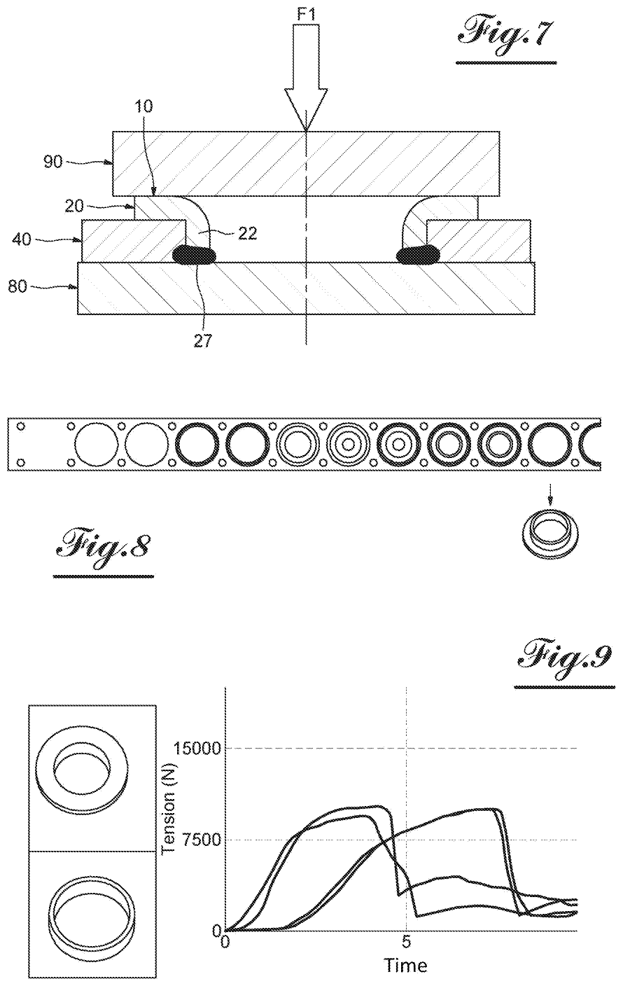

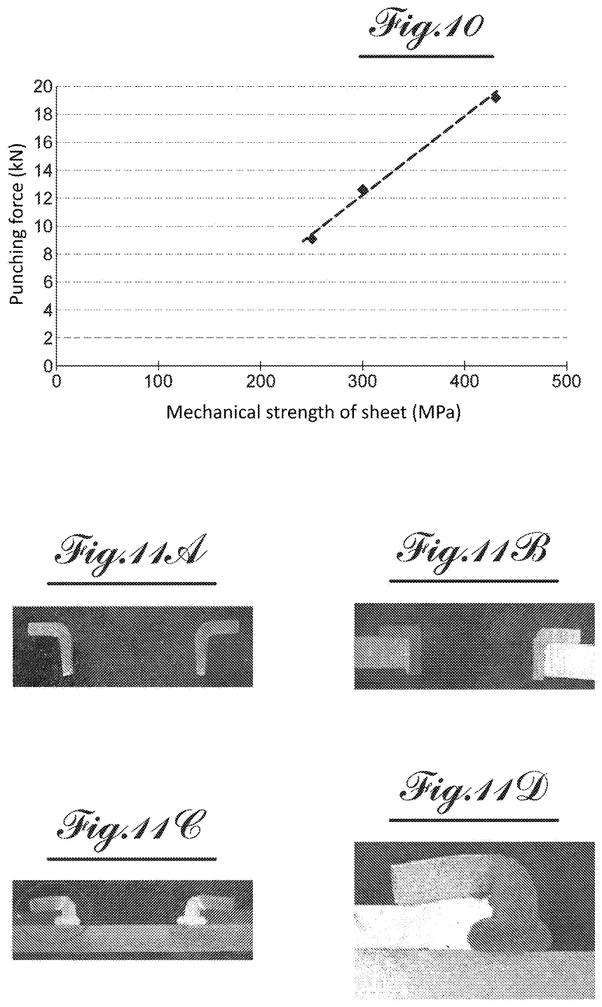

FIG. 8 illustrates the fabrication of a pin according to FIG. 1.

FIG. 9 shows an example of implementation at the stage in FIG. 4 with curves of the forces applied at the steps in FIGS. 2 to 4 in four separate implementations with sheet of same type.

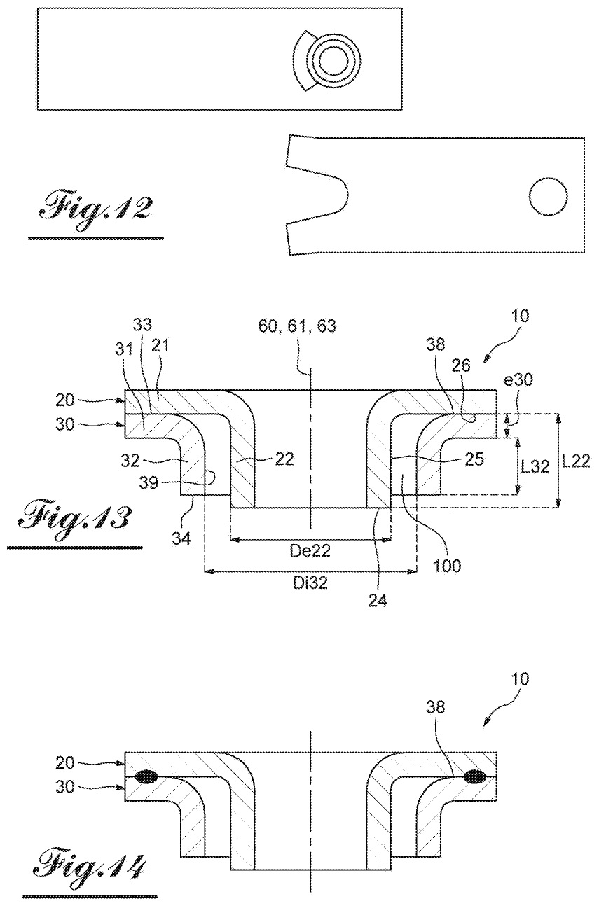

FIG. 10 shows the trend in force required for the punching in FIGS. 2 to 4 as a function of the strength of the punched sheet, in three separate implementations.

FIG. 11 shows the steps of FIGS. 2 to 4 and 6 and 7 in the form of micrographic sections.

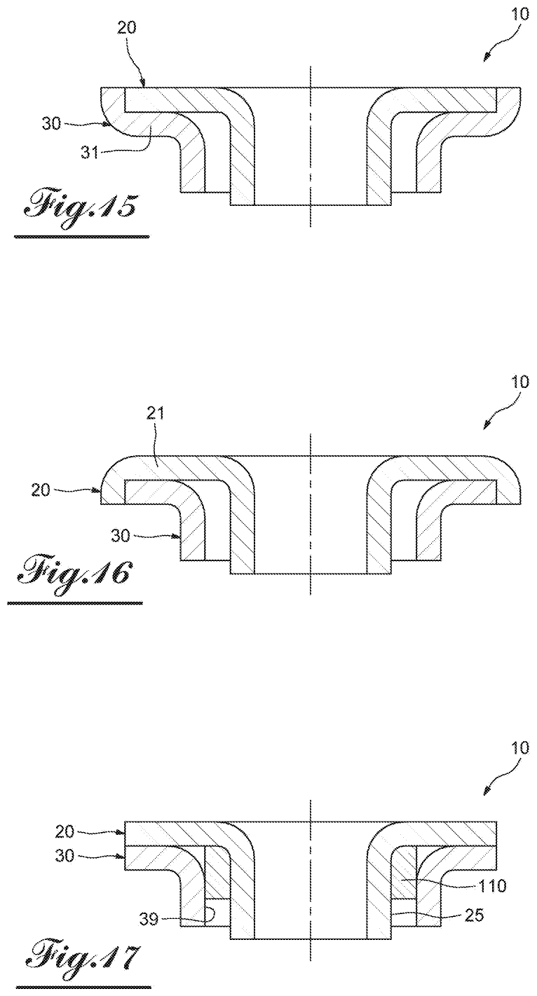

FIG. 12 shows an assembly between sheet in aluminium alloy and steel sheet, obtained with the method om completion of the step in FIG. 7, after rupture of the aluminium alloy sheet after a mechanical shear test at which the weld of the invention resisted.

FIG. 13 is a cross-sectional view of a pin according to a second embodiment of the invention.

FIGS. 14 to 17 give cross-sectional views of variants of the pin in FIG. 13.

FIG. 18 is a cross-section of the final implementation step of the pin in FIG. 13.

FIG. 19 is a cross-sectional view of another variant of the pin in FIG. 13.

FIG. 20 shows the composition of a pin in FIG. 13.

FIG. 21 gives the results after positioning of the pin in FIG. 13 on three sheets of different materials.

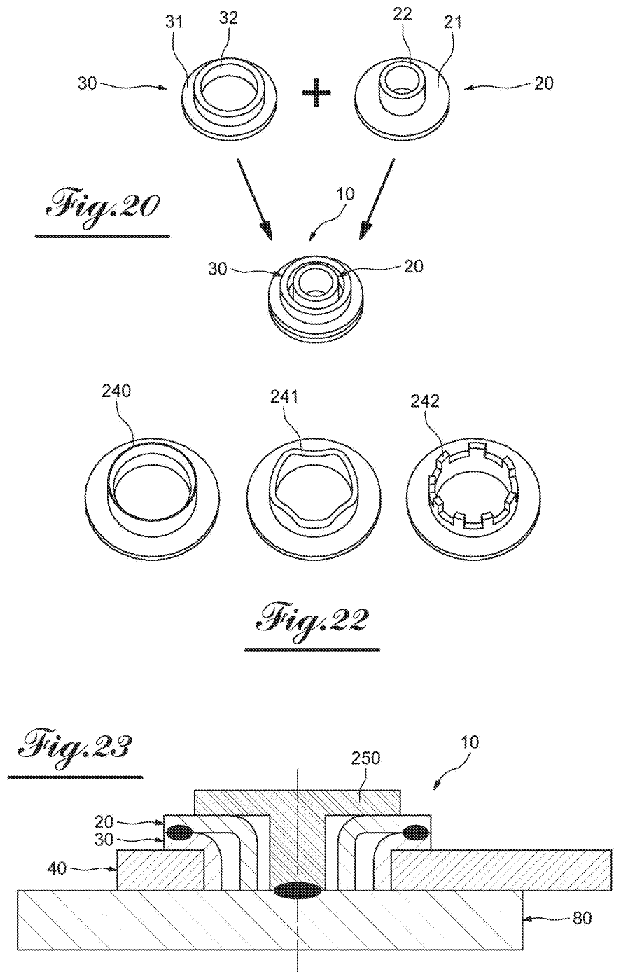

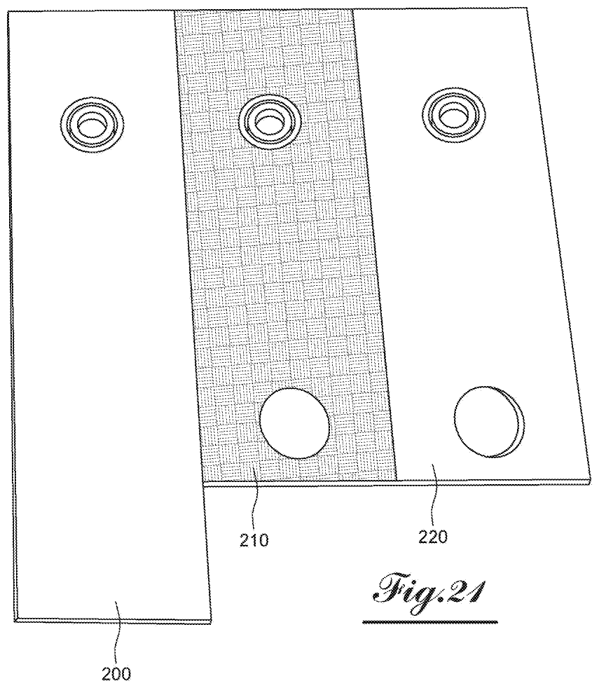

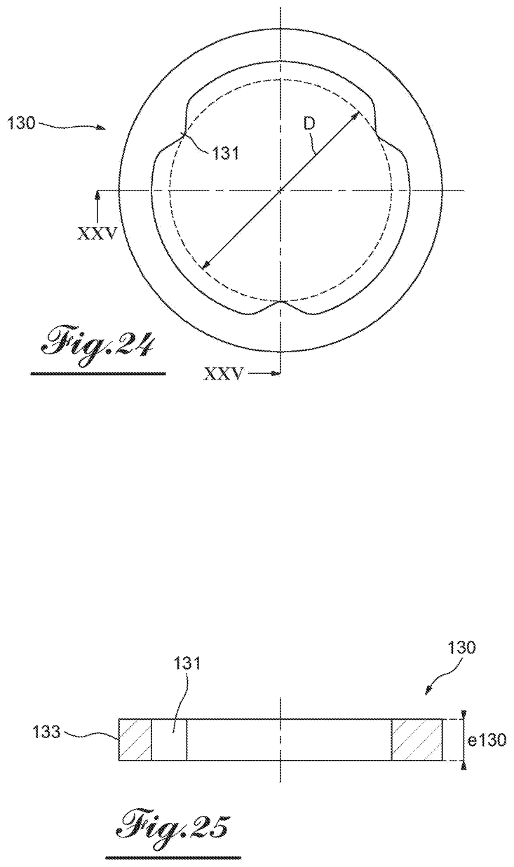

FIG. 22 illustrates three variants of a pin according to the first embodiment.

FIG. 23 illustrates a repair method conforming to one aspect of the invention of an assembly using the invention.

FIGS. 24 to 29 illustrate an additional embodiment of the invention.

FIG. 30 illustrates one embodiment of the fabrication of a welding pin according to the invention as an alternative of the embodiment in FIG. 8.

FIG. 31 illustrates a variant of positioning of the pin for some sheet materials.

In FIG. 1 a hollow welding pin 10 is illustrated according to a first embodiment of the invention which can be composed of a metal part 20 obtained by plastic deformation of sheet metal or of a bloom—or, according to one definition, a metal cylinder intended to be hot formed by rolling, extrusion or forging. The part is noteworthy in that it has a flange 21 in one plane and is extended on its lower surface by a shank of hollow cylinder of revolution shape 22 of length L22, perpendicular to the plane of the flange as seen from the lower surface of the flange 21, and having an axis of symmetry 60 perpendicular to the plane of the flange 21, in particular to its upper surface 23 (the furthest distant from the shank) which is planar. Therefore, the metal part 20 forms a tube.

In FIG. 2, the annular surface 24 of the end of the hollow cylindrical shank 22 opposite the flange 21 is planar and can be placed in contact with the flat upper surface 41 of a sheet 40 whereas the lower surface 42 of the sheet, also flat is applied against a punching die 50 allowing symmetry of revolution and of which the axis of symmetry merges with the axis of symmetry of the shank 22, and having an inner diameter larger than the outer diameter De22 of the shank following the rules defined by persons skilled in the art. To enable punching of the sheet 40, the mechanical strength of the part 20 must be greater than the mechanical strength of the sheet 40 and the length L22 of the shank 22 must be greater than the thickness of the sheet 40.

FIG. 3 illustrates the application of a force F increasing over time and perpendicular to the surface 23 which allows the annular surface 24 of the end of the cylindrical shank to conform to the upper surface of the sheet 40 which deforms elastically until the applied force F reaches a critical value Fe causing the elastic limit of the sheet 40 to be exceeded with the onset of plastic deformation and punching thereof until a pad (slug) 70 is formed in the deformed sheet 40, becomes detached therefrom and is evacuated by boring of the punching die. The tubular nature of the shank 22 facilitates radial elastic deformation of the pin 10 when punching. The elastic return of the sheet 40 after punching leads to contraction of the sheet around the outer diameter De22 of the shank 22 and hence to compressive stress on the outer surface 25 of the shank 22. Once the sheet 40 has been punched by the hollow welding pin 10, the outer surface 25 of the shank 22 slides over the inner cut surface, or edge, of the sheet 40 until the lower surface 26 of the flange comes to bear against the surface 41 of the sheet. The combined elastic returns of the sheet 40 and tubular shank 22 after punching lead to radial compression stresses on the outer surface 25 of the shank 22 having regard to contraction of the sheet 40 and extension of the shank 22.

In FIG. 4, at this stage, the hollow welding pin 10 is mechanically retained by the sheet 40 and has a projecting annular surface 24 on the sheet surface. The whole forms sheet ready to be resistance welded onto another sheet mostly composed of iron, via the annular surface 24 at the end of the shank of the hollow welding pin 10.

FIG. 5 Without limiting the invention and the scope of the description, the different steps of the punching operation of the sheet 40 by the hollow welding pin 10 can also be illustrated in FIG. 5 following the progress of punching force F as a function of time:

Reference 1: conforming of the contact between the annular surface of the shank end and the upper surface of the sheet;

Reference 2: elastic deformation of the sheet up to the critical punching force Fe;

Reference 3: plastic deformation of the sheet up to the critical punching force Fp;

Reference 4: punching of the sheet;

Reference 5: sliding of the outer shank surface over the inner punching surface;

Reference 6: contacting of the lower surface of the flange on the upper surface of the sheet and sudden increase in punching force.

In FIG. 6, the sheet 40 fitted with the hollow welding pin 10, or several similar pins, is positioned above the metal sheet 80 in steel, stainless steel (cast iron in some applications) i.e. mostly composed of iron, on an overlap region according to the technical specifications of the assembly. The annular projecting contact surface 24 is placed in contact with the upper surface 81 of the metal sheet 80 with a force F1 perpendicular to the planes of the two sheets and is applied onto the surface 23 via a resistance welding electrode 90.

In FIG. 7, the passing of current between the electrode 90 and the metal sheet 80, electrically earthed, causes the passing of current in the part 20, mostly in the shank 22, and leads to local melting of the end thereof in the vicinity of the annular contact surface 24, and to plastic deformation thereof forming a molten collapsed mass 27 under the effect of the force F1. The plastic deformation and applied forces cause plastic deformation of sheet 40 that has lower mechanical strength than the hollow welding pin, allowing first the offsetting of any variations in the thickness of sheet 40 and also the generation of a robust mechanical assembly scarcely sensitive to relaxation when in use.

Having regard to the fact that there is no thermal decoupling between the part 20 and sheet 40 after punching—there is contact between the outer shank surface and the inner surface or edge of the sheet in its punched zone—this assembly method is more indicated for assembling two metal sheets rather than a composite or thermoplastic sheet 40 onto sheet 80 that is mostly iron-based.

FIG. 8 gives an example of a deformation range of a hollow welding pin of the invention with a ten-step stamping/cutting process of low-alloy steel sheet having a thickness of 1 mm. The hollow welding pin has mechanical strength close to 500 MPa after forming (the mechanical strength of the part is inferred from Vickers hardness measurement). Alternatively, a thickness of 0.5 mm or 2 mm can be used as examples.

FIG. 30 illustrates another embodiment of the fabrication of a pin such as illustrated in FIGS. 1 to 7. It entails plastic deformation of steel bloom cut from a spool of steel wire (e.g. grade17B2) having a calibrated diameter optionally via extrusion e.g. 8 mm, and a few millimetres in length. In the Figure the different cold heading stations can be seen applying a die and punch. Removal of the punched-out pad (slug) at the end of the process forms the through hole.

FIG. 9 gives images of an example of the result of an operation of punching/retention of a hollow welding pin according to one embodiment of the invention on sheet as seen from one side and then the other. In the images the annular projecting surface of the shank of the hollow welding pin can be seen after punching, and the surface of the flange on which the electrode is later applied. After punching, the hollow pin remains trapped in the aluminium sheet (or other material if different sheet is used as mentioned above) via the mechanical retracting forces of the aluminium sheet after punching, optionally completed by slight swelling of the shank of the hollow pin. Therefore, the tubular nature of the shank 22 facilitates radial elastic deformation of the pin 10 at the time of punching.

FIG. 9 also shows the force curves for four punching tests of one same sheet in aluminium alloy of 2 mm thickness, characterized by mechanical strength of 250 MPa. The four tests evidence the good reproducibility of punching with a critical force Fp in the region of 9 000 N, whether the operation is conducted slowly or rapidly. Once punching is completed, it is hardly possible to unfasten the pin from the sheet since it has a form factor enabling it to be retained by the punched sheet; having regard to the thickness of the sheet the pin is of sufficient size for retaining thereof.

FIG. 10 Different tests were conducted with sheets to be punched with the pin, in aluminium alloy and of 2 mm thickness having different levels of mechanical strength of between 250 and 430 MPa. FIG. 10 evidences linear behaviour of punching force Fp as a function of the mechanical strength of the sheet for a constant thickness of 2 mm.

The different parts in FIG. 11 illustrate the different steps of assembling aluminium alloy sheet of 2 mm thickness onto steel sheet using a hollow welding pin of the invention, in micrographic sections after coating with a resin and polishing.

FIG. 11A Part a in FIG. 11 shows a cross-section of a hollow welding pin.

FIG. 11B Part b in FIG. 11 shows a hollow welding pin and the aluminium alloy sheet after the punching/retaining operation.

FIG. 11C Part c in FIG. 11 shows a hollow welding pin and the aluminium alloy sheet after the resistance welding operation onto steel sheet.

FIG. 11D Part d in FIG. 11 is an enlarged image in cross-section of one half of the hollow welding pin evidencing the welded zone and the phenomenon of plastic deformation of the shank end and aluminium alloy sheet. The image also evidences modification of the microstructure of the hollow welding pin at the shank, indicating priority passing of current when resistance welding.

FIG. 12 Finally, FIG. 12 is a photograph of an assembly between aluminium alloy sheet and steel sheet by means of a hollow welding pin of the invention after a mechanical shear test, evidencing failure of the aluminium sheet and not of the weld thereby demonstrating a certain level of mechanical strength of the assembly of the invention.

In the event of rupture of the aluminium alloy sheet, the force applied causing the rupture is directly dependent on the mechanical strength of the aluminium sheet and on the cross-sectional area resisting shear. Therefore, for aluminium alloy sheet having a thickness of 2 mm with mechanical strength of 250 MPa and cross-sectional area resisting shear of 30 mm², for example, the force causing rupture is equal to 7 500 N. In the case of a practical application e.g. the body of a vehicle, neither fracture of the hollow welding pin nor fracture of one of the sheets of the assembly is desirable. The result of the test given in FIG. 12 allows guaranteeing that the hollow welding pin will resist a maximum force of 7 500 N, meeting the requirements of application to hybrid automotive assembly.

FIG. 13 In a second embodiment shown in FIG. 13, and having some advantages, the hollow welding pin 10 of the invention can be composed of a first metal part 20 as previously described but having a shank that is positioned internally relative to the axis, and of a second metal part 30 having a shank positioned externally relative to the axis.

The inner 20 and outer 30 hollow parts have flanges 21 and 31 respectively, and hollow cylindrical shanks 22 and 32 having axes of symmetry 60 and 61 perpendicular to the upper 33 and lower 26 surfaces of the flanges 31 and 21 respectively, these two surfaces being planar rings.

The upper surface 33 of flange 31 has an annular surface 38 in contact with the lower surface 26 of flange 21 so that the flanges 21 and 31 are able to be mechanically assembled via apposition. The inner diameter Di32 of the outer shank 32 is strictly greater than the outer diameter De22 of the inner shank 22 so that the inner surface 39 of the outer shank 32 is never in contact with the outer surface of the inner shank 22. The consequence thereof is the generation of a void volume 100 between the shanks of the outer 30 and inner 20 parts. The length L22 of shank 22 is necessarily greater than the total height—measured from the upper surface of the flange to the end of the shank—of part 30, sum of the length L32 of the shank 32 and thickness e30 of the flange of the outer part 30, so that the hollow welding pin 10 has a projecting annular surface 24, the end of the inner shank 22 projecting beyond the outer shank 32.

FIG. 14 The outer 30 and inner 20 parts must be assembled together on the annular contact zone 38 by resistance welding, bonding, clamping or by plastic deformation to prevent any relative movement between the outer 30 and inner 20 parts when subjected to external stress.

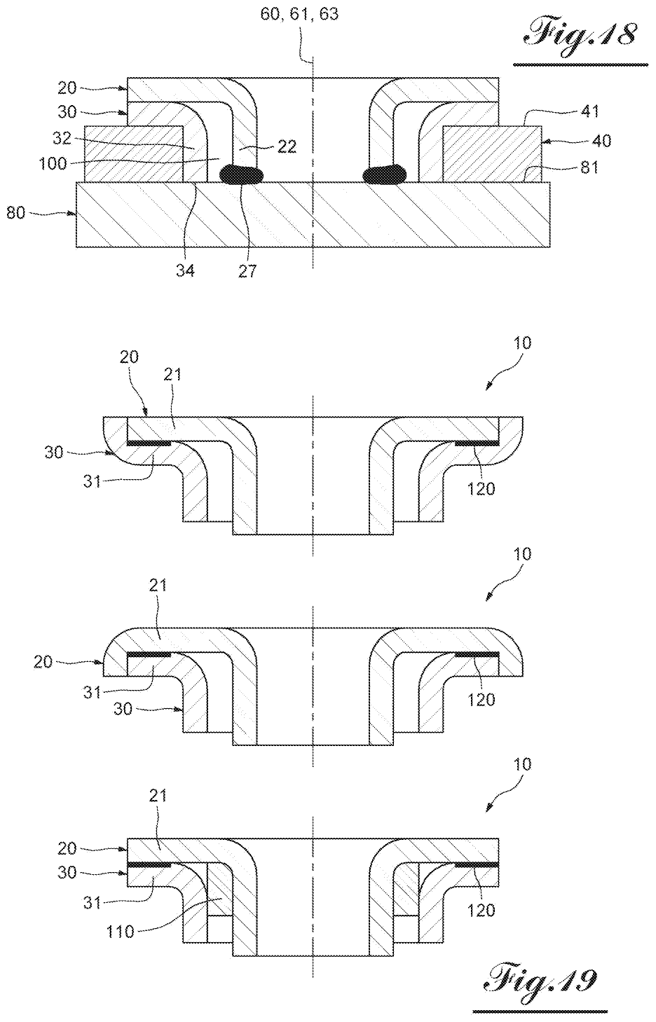

FIG. 15 The outer part 30 can also have an adapted shape at its flange 31 to receive the inner part 20 which can be mounted with tight fit as illustrated in FIG. 15.

FIG. 16 Conversely, the inner part 20 can also have a shape at its flange 21 adapted to receive the outer part 30 which can be mounted with tight fit as illustrated in FIG. 16.

FIG. 17 Finally, an additional part 110 can be force inserted between the inner surface 39 of the outer shank 32 and the outer surface 25 of shank 22, to maintain forced mechanical holding together of the outer 30 and inner 20 parts, as illustrated in FIG. 17.

Ideally, when assembling the outer 30 and inner 20 parts, the shanks 32 and 22 have the same axis of symmetry 63 so that the distance separating the surfaces 39 and 25 is constant to create a void volume 100 having symmetry of revolution about axis 63. The separation can be at least 0.5 mm, for example 1 mm, to be adapted according to exact implementation.

FIG. 18 The different steps of the punching operation described previously with the first embodiment of the hollow welding pin can be repeated with the second embodiment of the hollow welding pin composed of outer 30 and inner 20 parts. One difference is the presence of the annular projecting surface 24 of the inner shaft which comes into contact with the upper surface 41 of the sheet 40 before the annular projecting surface 34 of the outer shank. This difference has a favourable effect on the punching operation since it allows the sheet 40 to be locally placed under tensile stress, before the annular projecting surface 34 starts the punching operation.

The punching/retaining operation can be reproduced on different zones of sheet 40 as a function of the technical specification of the future assembly with the metal sheet 80.

The resistance welding operation to assemble the sheets 40 and 80 is similar to the operation described for the first embodiment of the hollow welding pin, using the annular surface 24 of the inner part 20 for welding. Preferably, a low-alloy steel having good weldability is used for this inner part 20, such as C10 steel, DC01 steel, or 17B2 steel. Conversely, the steel used for the outer part 30 is preferably a stainless steel to prevent corrosion in contact with sheet in composite carbon fibre material in particular.

However, a difference is seen. When resistance welding, the void volume 100, naturally filled with air, acts as thermal resistance and protects the sheet 40 against a rise in temperature that is too high which could harm the mechanical properties thereof, in particular if the sheet 40 is composed of a composite or thermoplastic material. The void volume 100 also allows flow of the material of the shank 22 of the inner part 20 under force F1, that is slackened, softened under resistance welding.

The possibility of obtaining plastic deformation of the shank 22 at the resistance welding operation allows any variations in thickness of the sheet 40 to be offset and generates a robust mechanical assembly scarcely sensitive to relaxation when in use.

The use of two parts, outer 30 and inner 20, to carry out the second embodiment of the hollow welding pin allows the combining of different materials for the two parts and prevents the development of galvanic corrosion of the assembly in the event of association of a carbon fibre composite with steel sheet in the presence of humidity when in use. With the second embodiment of the hollow welding pin of the invention, the outer part 30 in contact with the part in carbon fibre composite material can be manufactured in stainless-steel, whereas the inner part 20 in contact with the steel part can be manufactured in a low-alloy steel to guarantee the quality of resistance welding. Under these conditions, the durability and mechanical strength of an assembly between sheet in carbon fibre composite material and a second sheet in steel is guaranteed.

In another example, the outer part 30 can be manufactured in deformable steel which, after forming, is subjected to quenching heat treatment optionally followed by tempering to obtain a strong increase in the mechanical properties thereof. Under these conditions, the outer part 30 allows facilitated punching of the sheet 40, whereas the inner part 20, in mild steel, allows quality welding with sheet 80 that is mostly composed of iron.

In another example, the outer part 30 can be manufactured in a refractory material having high mechanical strength to facilitate punching and obtain a maximum reduction in heat exchange between the outer part 30 and the sheet 40 when welding the inner part 20 onto sheet 80 mostly composed of iron.

FIG. 19 Finally, an electrically insulating part 120 can be positioned between the flanges 21 and 31 of the inner 20 and outer 30 parts so that no electric current passes through the outer part 30 when welding part 20, and to prevent any contact of the surface 34 with the earthed sheet 80. Under these conditions, additional heat protection is imparted to sheet 40, since part 30 is not heated by the passing of electric current when welding.

Part 120 in the preceding example can be replaced by insulating surface treatment, temperature-resistant and located on the upper surface 33 of the flange 31. Said surface treatment can be performed by dry route—e.g. PVD, thermal spray coating—and can be composed of a refractory oxide such as Al2O3.

The presence of an intermediate part 120 or of local surface treatment must not hinder mechanical assembly of the parts 20 and 30. Under these conditions, assemblies such as those illustrated in FIGS. 15, 16 and 17 can be envisaged.

FIG. 20 shows the combination of the inner 20 and outer 30 parts to form the second embodiment of the hollow welding pin of the invention.

FIG. 21 illustrates three cases of punching in three sheets of 2 mm thickness and of different types: aluminium alloy with mechanical strength of 430 MPa for sheet 200, composite with 80% carbon fibres and 20% epoxy resin for sheet 210, non-saturated polyester with 29% glass fibre filler for sheet 220. For these three materials, the punching forces are 18 600, 9 300 and 4 500 N respectively. FIG. 21 evidences the good quality of punching for the different types of materials. The principles of the invention are applicable even with the high mechanical strength of sheet 200 namely 430 MPa as previously mentioned.

For both embodiments of the hollow welding pin, the free end of the shank 22 or 32, the part welded onto the steel sheet, can have an inner chamfer, or waving or crenellations on its perimeter, or any other form not hindering the punching operation but allowing a reduction in the contact surface with the steel sheet 80 when resistance welding. Under these conditions, the intensity of the weld current can be decreased and also heating of the different parts through which the current passes.

FIG. 22 illustrates three examples of hollow welding pin according to the first embodiment, having three different geometries of the annular projecting surface of the free end of the shank: with an inner chamfer (oriented towards the inside of the cylinder) for annular surface 240, with waving along the perimeter (of amplitude parallel to the axis) for annular surface 241, and with crenellations along the perimeter (the sides of the crenellations being parallel to the axis) for annular surface 242.

Experience has shown that chamfered or waved shanks exhibit good behaviour when punching even with sheet having mechanical strength higher than 300 MPa, whereas crenellations at the end of the shank tend to collapse during punching.

FIG. 23 illustrates the possibility of an addition in the event of failed welding of the hollow pin given for illustration, according to the second embodiment with hollow parts 20 and 30, to take advantage of the hollow nature of the pin, which in this hypothesis remains in place despite failure thereof, to carry out a simple repair. In this case, the hollow of the hollow pin is used to insert the shaft of a standard pin 250 which is then welded by electric welding by applying an electrode to the pin head, accessible above the hollow pin, opposite the free end of its shaft which is in contact with sheet 80. The same principle is applicable to the hollow pin of the first embodiment of the invention. In addition, the head of the standard pin bears against the outer surface of the flange of the hollow pin to clamp together the two sheets 40 and 80, one in steel and the other either in aluminium or a composite or other material.

FIG. 24 With reference to FIGS. 24 to 29, another approach to provide efficient heat protection for sheet 40 when it is assembled with steel sheet 80, is to fabricate a washer 130 having on its inner diameter three radially projecting parts 131 the ends of which are distributed over a diameter D about the axis of the washer, very slightly smaller than the outer diameter of the shank 22 of the inner hollow part 20.

FIG. 25 This washer also has a thickness e130 narrower than the height L22 of the shank 22 of the inner hollow part 20.

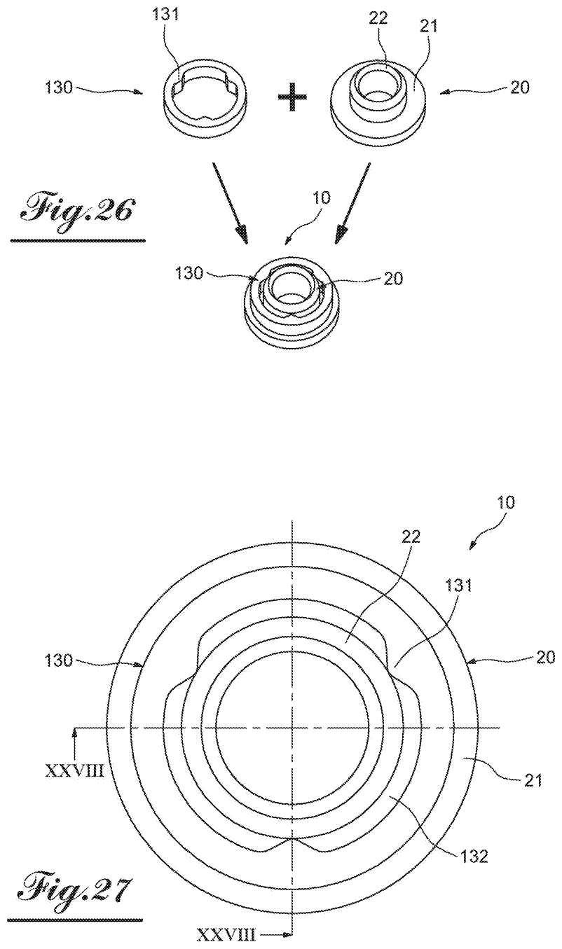

In FIG. 26 the assembly can be seen of the washer 130 on the inner hollow part 20, more specifically on the shank 22 thereof. The washer 130 is pushed until it meets the surface of the flange 21 oriented towards the shank 22, to form the hollow welding pin 10.

FIG. 27 Therefore, the washer 130 can be force mounted onto the shank 22 with only three points of contact at 120° from each other for example, generating a stable support of the washer 130 on the shank 22, and three volumes of air 132 in succession over three angular sectors of the toroidal space between the shank 22 and the washer 130. These volumes of air 132 are delimited from each other by the radially projecting parts 131. The distance between diameter D and the outer diameter of the shank 22 is controlled to ensure force mounting so that the washer 130 cannot be separated from the part without the application of substantial external force.

FIG. 28 Once the washer 130 is secured to part 20, the outer surface 133 of the washer is used for punching sheet 40 and for retaining thereof in the sheet 40. The outer diameter of the washer 130, referenced De130, is necessarily smaller than the outer diameter of the flange 21 of part 20, referenced De21, so as to generate an annular contact surface 134, on the flange surface facing the shank, with the sheet 40 after punching. This contact surface is composed of the flange surface facing the shank which projects beyond the washer 130 on account of the smaller diameter thereof. The surface 134 guarantees the mechanical strength of the assembly of sheets 40 and 80 after welding, preventing unfastening.

The end 24 of the shank 22, opposite the flange 21, can advantageously have a double chamfer to increase contact strength when welding with steel sheet 80 thereby reducing the intensity of the weld current.

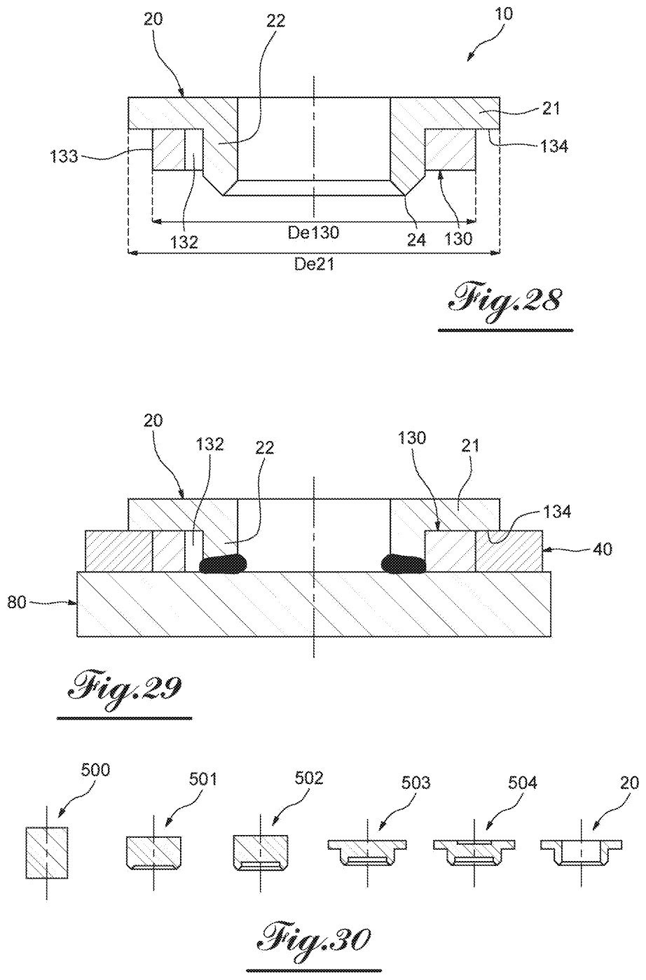

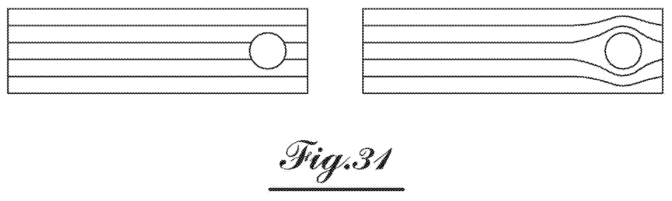

FIG. 29 When welding the end 24 of the shank 22, the diffusion of heat within the washer 130 can only occur via the three projecting parts 131, and is therefore very limited. The washer 130 therefore heats much less than the shank 22 at the resistance welding operation. Considering the heat loss in the washer 130, the sheet 40 which receives heat via the washer heats less than the washer and the shank 22. The washer 130 can advantageously be fabricated in material having reduced heat conductivity for maximum limiting of heating of the sheet 40. For example, the washer 130 can be made in stainless steel or refractory steel. The washer 130, from the viewpoint of desired reduced cost of manufacture, can advantageously be produced by stamping.

In the foregoing, the insertion was mentioned of the pin having one or two parts into sheet in non-electrically conductive material via punching with de-slugging and retaining of the pin. Alternatively, if the sheet in non-electrically conductive material is produced by moulding or compression of rolling, thermocompression, stamping type, which is easily the case if the material is a thermoplastic polymer material, a thermosetting resin or composite material comprising woven fibres impregnated with a polymeric resin, then the pin, or if the pin is two parts the outer part of the pin (the additional cylinder) can be inserted into the sheet as soon as it is hot formed via overmoulding. The pin (or outer part of the pin if the pin is in two parts) is then retained by contraction of the material around the shank on cooling.

FIG. 31 If the moulded or rolled material is a thermoplastic reinforced with long fibres of which at least some are oriented in a single direction in the plane, cutting the long fibres by punching is avoided since the long fibres can be locally arranged in the material around the pin, the presence of the pin diverting the fibres locally either side of the position of the pin in the sheet without jeopardising the regular presence of the long fibres throughout the part upstream and downstream of the pin in the direction of the fibres. This allows ensured solidity of the part with the fibres maintaining all their integrity, and therefore ensuring whenever needed the transmission of forces from downstream to upstream of the pin, or vice versa.

This implementation by inserting the pin at the time of manufacturing the part is particularly envisioned for the pin having two parts, the outer part providing heat protection for the polymer or composite material at the electric welding step. It is specified that the inner part of the pin can be present at the time of overmoulding or it can be inserted later.

The invention particularly applies to the automotive sector for the assembling of body parts or body shell in steel or aluminium alloy, or for the assembling of parts in steel and polymer material, or composites.

1. A method for assembling a sheet (40) and an iron-based metal part (80) comprising a step of fitting a tubular pin (10) which is open at both ends by punching through the sheet (40) with a shank of the pin with the pin being retained (10) by the sheet, wherein a pad (70) is detached from the first sheet (40), and a flange of the pin abuts against the surface of the sheet (40) once the through-punching has been carried out, and the elastic returns of the shank of the pin (10) and the sheet (40) compress the outer surface of the shank, or by overmoulding the pin in the sheet, and subsequently a step of welding a metal tube of the pin (10) to the iron-based metal part (80) by bringing a free end (24) of the metal tube into contact with the surface of the iron-based metal part (80) by means of electric resistance welding (90), the tube being electrically conductive, and on one surface of the sheet has a bell mouth (21) and on the other surface of the sheet has the free end (24).

2. (canceled)

3. A method for assembling for mechanical assembly according to claim 1, wherein it is a sheet in aluminium alloy (200), or a sheet of polymer (220) with or without fibrous reinforcement, or a sheet in composite material with organic or ceramic matrix (210) with or without fibre reinforcement.

4. A method for assembling for mechanical assembly according to claim 1, wherein the material of the metal tube open at both ends (20) is held away from the material of the sheet (40) by an additional tube (30), the free end (24) of the metal tube open at both ends projecting beyond a free end (34) of the additional tube (30).

5. A method for assembling for mechanical assembly according to claim 4, wherein the additional tube (30) is in stainless steel, hardened steel, or in a non-metallic heat-refractory material.

6. A method for assembling for mechanical assembly according to claim 4, wherein the metal tube open at both ends (20) and the additional tube (30) are assembled by welding, bonding, clamping or plastic deformation between respective end flanges (21, 31) of the tubes on the bell mouth side, or locked to each other by inserting a shim (110) between an inner surface of the additional tube and an opposite-facing outer surface of the metal tube open at both ends, or via the presence on the inner diameter of the additional tube of radially projecting parts (131) promoting embedding of the additional tube around the metal tube open at both ends (20).

7. A method for assembling for mechanical assembly according to claim 4, wherein electrical insulation (120) is comprised between the material of the metal tube open at both ends and the material of the additional tube.

8. A method for assembling for mechanical assembly according to claim 4, wherein a gap is comprised over the cylinder development and height of the electrically conductive metal tube between the material of the metal tube open at both ends (20) and the material of the additional tube (30).

9. A method for assembling a sheet (40) and an iron-based metal part (80) comprising a step of fitting a hollow pin, with retention of the pin by the sheet, by punching through the sheet (40) with a shank of said hollow pin (10), a pad (70) being detached from the sheet (40), a flange of the pin coming to abut the surface of the sheet (40) once through-punching has been carried out, or by overmoulding said shank in the sheet (40), and subsequently a step of welding a metal cylinder of the pin (10) onto the iron-based metal part (80) by bringing the free end (24) of the metal cylinder into contact with the surface of the iron-based metal part (80) and welding by electric resistance (90), for mechanical assembly the through hollow cylinder being in electrically conductive material (20) which, on one surface of the sheet having a bell mouth (21) which comes to abut the surface of the sheet (40) and which on the other surface of the sheet has a free end (24).

10. The method for assembling a sheet and a metal part according to claim 9, wherein the electrode for electric resistance welding (90) is sized and applied so that all the angular sectors of the metal cylinder are simultaneously used to transmit energy for welding.

11. (canceled)

12. A method for assembling for mechanical assembly according to claim 9, wherein it is a sheet in aluminium alloy (200), or a sheet of polymer (220) with or without fibre reinforcement, in particular long fibre reinforcement, or a sheet in composite material with organic or ceramic matrix (210) with or without fibre reinforcement, in particular long fibre reinforcement.

13. A method for assembling for mechanical assembly according to claim 9, wherein the hollow metal cylinder (20) is in stamped low-alloy steel.

14. A method for assembling for mechanical assembly according to claim 9, wherein the material of the hollow metal cylinder (20) is held away from the material of the sheet (40) by an additional cylinder (30) of the pin, the free end (24) of the hollow metal cylinder projecting beyond a free end (34) of the additional cylinder (30).

15. A method for assembling for mechanical assembly according to claim 14, wherein the additional cylinder (30) is in stainless steel, hardened steel or a non-metallic heat-refractory material.

16. A method for assembling for mechanical assembly according to claim 14, wherein the hollow metal cylinder (20) and the additional cylinder (30) are assembled by welding, bonding, clamping or plastic deformation between respective end flanges (21, 31) of the cylinders on the bell mouth side, or locked to each other by inserting a shim (110) between an inner surface of the additional cylinder and an opposite-facing outer surface of the hollow metal cylinder, or by the presence on the inner diameter of the additional cylinder of radially projecting parts (131) promoting embedding of the additional cylinder around the hollow metal cylinder (20).

17. A method for assembling for mechanical assembly according to claim 14, wherein electrical insulation (120) is comprised between the material of the hollow metal cylinder and the material of the additional cylinder.

18. A method for assembling for mechanical assembly according to claim 14, wherein a gap is comprised over the cylinder development and height of the cylinder in electrically conductive material, between the material of the hollow metal cylinder (20) and the material of the additional cylinder (30).

19. A method for assembling for mechanical assembly according to claim 9, wherein the free end of the hollow metal cylinder (20) is smooth or has a chamfer (240), or has waving on its perimeter (241), or has crenellations on its perimeter (242).

20. (canceled)

21. A method for assembling for mechanical assembly according to claim 9, wherein the assembly is included in a structure of an automotive vehicle.

22. A method for an assembly of a sheet (40) and an iron-based metal part (80) comprising a hollow pin comprising a hollow cylinder in electrically conductive metal (20) passing through the sheet (40) and of which one end has a bell mouth (21) abutting the surface of the sheet (40), the hollow metal cylinder (20) being welded onto the iron-based metal part (80), in the event of weld failure, wherein the shaft of a metal conductor (250) composed of a head and shaft of length chosen for the repair being positioned in the hollow of said cylinder in electrically conductive metal (20), the head being placed against the bell mouth (21) of the cylinder (20) and an electric welding electrode being applied to the head to weld the shaft to the sheet.
